(19) United States
(12) Patent Application Publication
(10) Pub. No.: US 2017/0371494 A1
(43) Pub. Date: Dec. 28, 2017

(54) Electronic device and control program

(71) Applicant: SEIKO EPSON CORPORATION, Tokyo (JP)

(72) Inventor: Kosuke SHINGAI, Matsumoto (JP)

(21) Appl. No.: 15/628,486

(22) Filed: Jun. 20, 2017

(30) Foreign Application Priority Data
Jun. 24, 2016 (JP) 2016-125214

(51) Int. Cl. G06F 3/042; H04W 52/02; G06K 9/00

(52) U.S. Cl. CPC G06F 3/0421; G06K 9/00335; H04W 52/027

(57) ABSTRACT

An electronic device has a touch panel configured to detect a touch position; and a controller configured to detect the touch position with greater precision in a first area that includes the touch position than in a second area that is different from the first area.

The entire disclosure of Japanese Patent Application No: 2016-125214, filed Jun. 24, 2016 is expressly incorporated by reference herein in its entirety.

### BACKGROUND

### 1. Technical Field

The present invention relates to an electronic device having a touch panel, and to a control program for the electronic device.

### 2. Related Art

Optical touch panels are now common. For example, JP-A-2010-134610 describes power conservation technology for an electronic device having an optical touch panel, the power conservation technology turning off either or both the plural light-emitting elements or plural light detectors when the required detection precision is low.

JP-A-2010-134610 describes saving energy when a list is displayed on the touch panel by turning off some of the light-emitting elements or light detectors used to detect movement of a finger in the direction perpendicular to the direction in which the elements of the list are arranged.

For example, JP-A-2010-134610 (paragraph [0050]) describes conserving power when a list is displayed on a touch panel by turning off some of the light-emitting elements or light detectors for detecting movement of the finger in the direction perpendicular to the direction in which the elements of the list are arranged. In addition to a configuration that passively sets the light-emitting elements or light detectors to turn off according to the content displayed on the touch panel, improved power conservation technology is desired.

### SUMMARY

An objective of the present invention is to reduce power consumption by a touch panel.

An electronic device achieving the foregoing objective has a touch panel configured to detect a touch position; and a controller configured to execute a detection operation with greater power consumption per unit area in a first area including the touch position than in a second area different from the first area.

Another aspect of an electronic device achieving the foregoing objective has a touch panel configured to detect a touch position; and controller configured to predicts the destination to which the touch position moves, and in a first area containing the touch position and the destination, detect the touch position with greater precision than in a second area that is different from the first area.

The method of detecting the touch position with greater precision in the first area than the second area may be conceived of as setting the detection frequency of the touch position greater in the first area than in the second area, or setting the number of touch position detection elements that are driven (operated) in the same unit area greater in the first area than in the second area, that is, setting the detection resolution higher in the first area than in the second area.

Because power consumption also generally increases when the detection precision rises, the invention can also be conceived in terms of precision.

Thus comprised, an area inside touch operation acceptance areas that are set according to the display content of the touch panel can be set as the first area. The position detection precision in second areas is lower than in first areas. The configuration of the invention therefore enables reducing power consumption compared with a configuration that sets all of the touch operation acceptance areas as the first area.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a block diagram illustrating the configuration of a printer.

FIG. 2 illustrates the configuration of the touch panel.

FIG. 3 shows an example of a display screen.

FIG. 4 is a flow chart of a touch position detection control process.

FIG. 5 illustrates a detection region.

FIG. 6 illustrates a detection region.

FIG. 7 illustrates a detection region.

FIG. 8 illustrates a detection region.

FIG. 9 illustrates a detection region.

FIG. 10 illustrates a detection region.

FIG. 11 illustrates a detection region.

FIG. 12 illustrates a detection region.

### DESCRIPTION OF EMBODIMENTS

A preferred embodiment of the present invention is described below with reference to the accompanying figures. Note that like parts in the accompanying figures are identified by the same reference numerals, and redundant description thereof is omitted.

### 1. Embodiment 1

### 1-1. Configuration

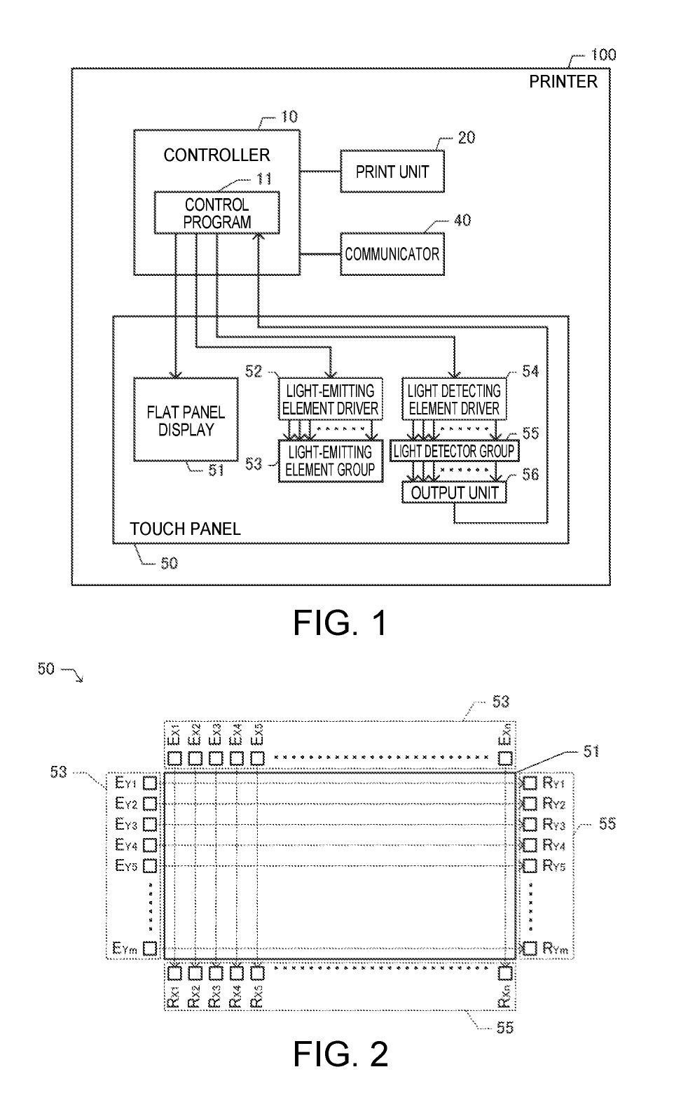

FIG. 1 is a block diagram illustrating the configuration of a printer 100 used herein as an example of an electronic device according to the invention. The printer 100 has a controller 10, print unit 20, communicator 40, and touch panel 50.

The print unit 20 has actuators, sensors, drive circuits, and other mechanical components for printing on such print media as photographic paper, plain office paper, and OHP film using an inkjet, electrophotographic, or other printing method.

The communicator 40 has one or more communication interfaces for communicating by wire or wirelessly with external devices. The communicator 40 also has an interface for communicating with removable media that may be installed to the printer 100.

FIG. 2 illustrates the configuration of the touch panel 50. The touch panel 50 has a flat panel display 51 with a rectangular screen. The flat panel display 51 includes an LCD panel embodying the screen, and a drive circuit for driving the LCD panel.

As shown in FIG. 1 and FIG. 2, the touch panel 50 includes a light-emitting element group 53 of numerous light-emitting elements; a light-emitting element driver 52; a light detector group 55 including numerous light detecting elements; a light detecting element driver 54; and an output unit 56. The many light-emitting elements EX1 to EXn, and EY1 to EYm, of the light-emitting element group 53 are disposed at equal intervals on two adjacent sides of the flat panel display 51. The light-emitting elements EX1 to EXn, and EY1 to EYm, embody the light source of the display. The many light-detecting elements RX1 to RXn, and RY1 to RYm, of the light detector group 55 are likewise disposed at equal intervals on the other two adjacent sides of the flat panel display 51.

The light-emitting element driver 52 is a circuit that individually turns the many light-emitting elements on and off.

The light detecting element driver 54 is a circuit that turns the light detecting elements corresponding to the light-emitting elements that are emitting on, and turns the other light detecting elements off.

The output unit 56 is a circuit that outputs a detection signal indicating the output of each of the plural light detecting elements.

The light-emitting elements EX1 to EXn, and EY1 to EYm, are LEDs configured as point sources of light, and emit light in the direction parallel to the screen of the flat panel display 51. Two or more light-emitting elements EX1 to EXn, and EY1 to EYm, do not emit simultaneously, and the light-emitting elements that emit change sequentially. In this example, the direction parallel to the long side of the screen of the flat panel display 51 is referred to as the horizontal direction (horizontal axis) of the screen, and the direction parallel to the short side of the screen of the flat panel display 51 is referred to as the vertical direction (vertical axis) of the screen.

Light emitted from the light-emitting elements EX1 to EXn arrayed on the horizontal axis crosses the screen of the flat panel display 51 on the vertical axis, and is incident to the corresponding light detecting elements RX1 to RXn on the opposite side of the screen of the flat panel display 51 as the light-emitting elements EX1 to EXn.

Light emitted from the light-emitting elements EY1 to EYm arrayed on the vertical axis crosses the screen of the flat panel display 51 on the horizontal axis, and is incident to the corresponding light detecting elements RY1 to RYm on the opposite side of the screen of the flat panel display 51 as the light-emitting elements EY1 to EYm

The light-detecting elements RX1 to RXn, and RY1 to RYm, in this example are photodiodes. When the screen of the flat panel display 51 is touched with a finger or stylus, the finger or style interrupts one or more light paths crossing the screen, and the output of the light detecting elements corresponding to the interrupted light paths decreases. As a result, based on detection signals output from the output unit 56, the controller 10 can know the position that was touched (referred to below as the touch position) by the finger or stylus on the screen of the flat panel display 51.

The controller 10 has a CPU, ROM, RAM, and other peripheral circuits not shown, and using RAM or nonvolatile memory, the CPU executes a control program 11 recorded in ROM or other nonvolatile memory. An ASIC may execute at least some processes in addition to the CPU or instead of the CPU. The control program 11 is a program that causes the controller 10 to implement functions including displaying information on the touch panel 50, and controlling parts of the printer 100 to execute processes corresponding to touch operations (such as taps and swipes) on the screen of the flat panel display 51 based on touch position information acquired from the touch panel 50. More particularly in this embodiment, the control program 11 has a touch position detection control function for individually turning the light-emitting elements of the light-emitting element group 53, and the light detecting elements of the light detector group 55, on and off based on the touch position and predicted destination of touch movement on the touch panel 50.

### 1-2: Touch Position Detection Control

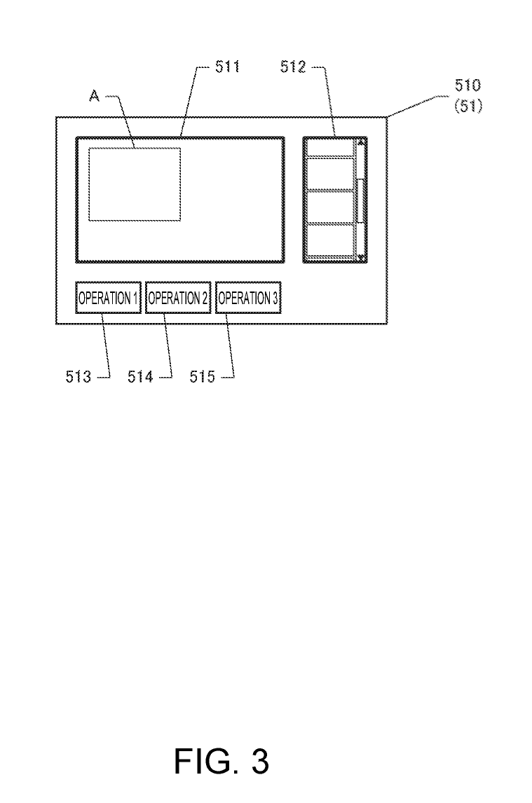

FIG. 3 shows an example of a screen configuration used to describe the touch position detection control function. The screen 510 shown in FIG. 3 is a screen displayed on the flat panel display 51, and supposes a screen for editing the communication area of a postcard. Areas of the screen 510 for accepting touch operations (referred to below as touch operation acceptance areas) in this example include a free-design area 511, list area 512, and button areas 513, 514, 515.

The free-design area 511 is an area allowing a picture A to be moved and placed anywhere in the free-design area 511, and accepts swipes (operations involving moving the touch position while touching the screen). Tap operations on the picture A are also allowed (can be detected).

The list area 512 is an area where elements in a list are displayed in a vertically scrollable area, and swipe operations on the vertical axis for scrolling the list elements vertically are allowed (can be detected). In other words, the list area 512 is a restricted area in which the effective detection component of a swipe operation is limited to movements on the vertical axis of the screen. Tap operations on the list elements in the list area 512 are also allowed.

The button areas 513, 514, 515 are areas for accepting commands to execute the corresponding operation 1, operation 2, and operation 3. Tap operations are accepted in button areas 513, 514, 515, but swipe operations are not allowed. Note that the button areas 513, 514, 515 and free-design area 511 are not restricted areas.

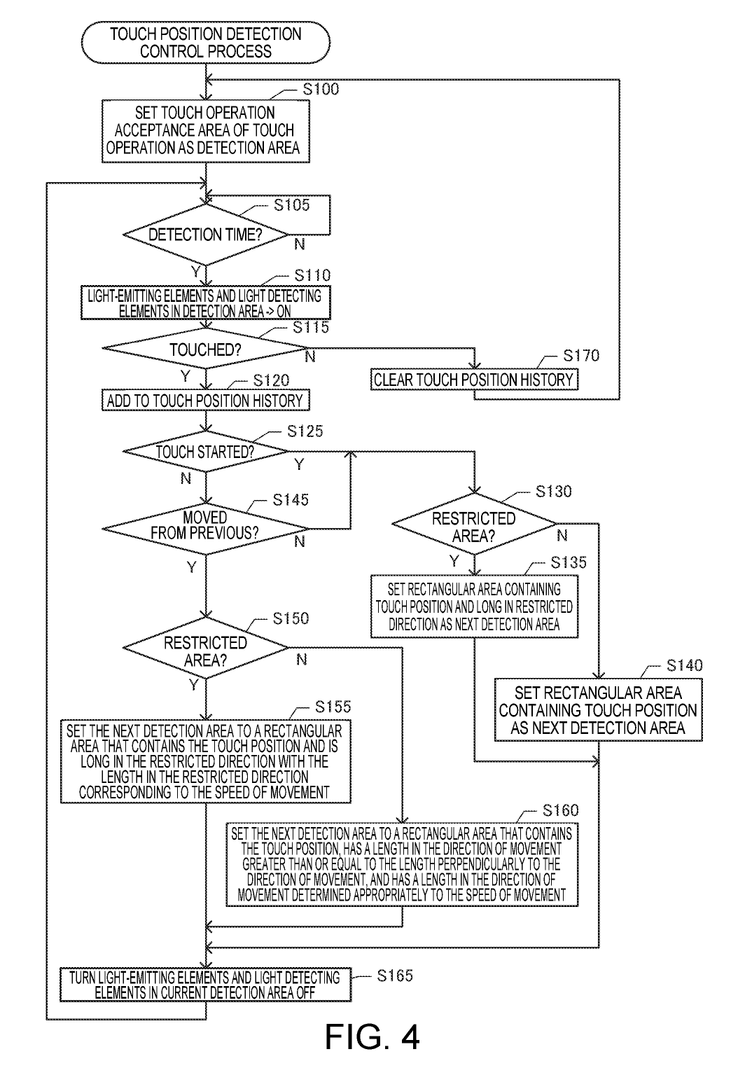

The touch position detection control process shown in the flow chart in FIG. 4 is described using the example of the screen 510 shown in FIG. 3 displayed on the flat panel display 51. The touch position detection control process shown in FIG. 4 is a process for controlling the detection area for detecting the touch position. Processing events corresponding to touch operations including taps and swipes is handled by a separate module, and description thereof is omitted below.

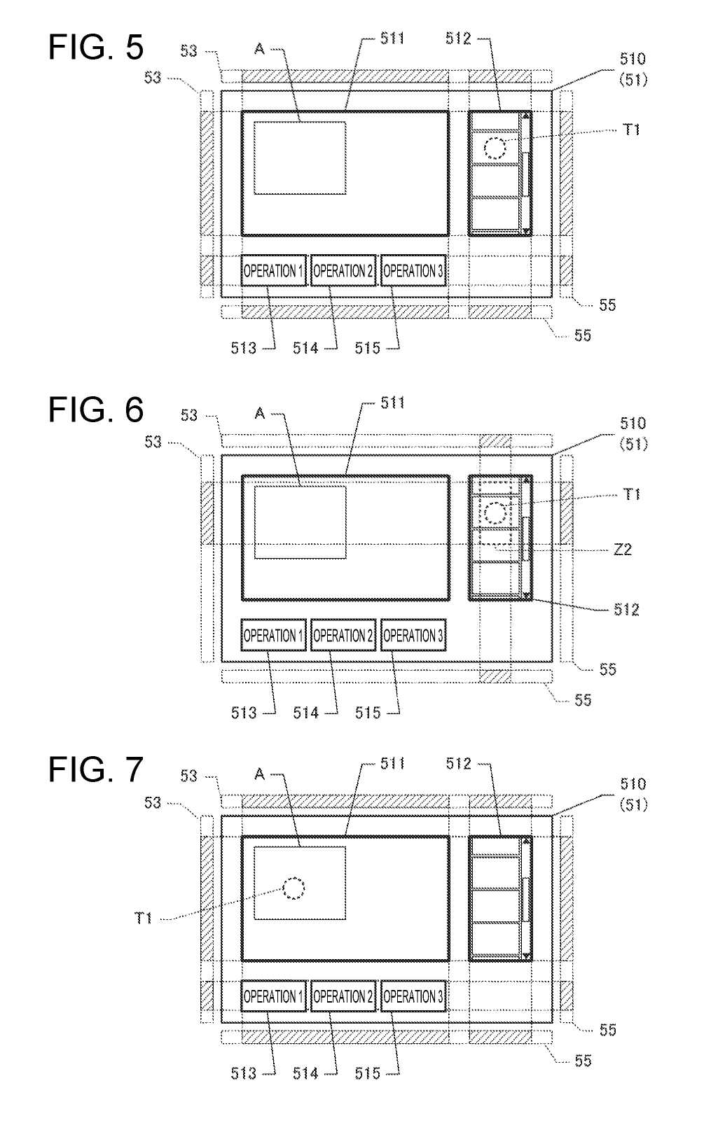

The process shown in FIG. 4 starts when the screen 510 is brought to the front for user interaction. The controller 10 first sets, as detection areas, the smallest areas including the touch operation acceptance areas (step S100). The hatched areas in FIG. 5 indicate the ranges of light-emitting elements and light detecting elements corresponding to the smallest areas containing the touch operation acceptance areas (that is, free-design area 511, list area 512, and button areas 513, 514, 515) on the screen 510. When step S110 executes after step S100, only the light-emitting elements and light detecting elements in the hatched areas in FIG. 5 are actually on. Because the light-emitting elements and light detecting elements corresponding to the areas outside these detection areas are off, power consumption per unit area is lower, and detection precision is lower, than in the areas where these elements are on. This enables conserving power compared with when all light-emitting elements and light detecting elements in the flat panel display 51 are on. Note that the detection areas described above are examples of first areas in the accompanying claims, and the areas of the flat panel display 51 outside the detection areas are examples of second areas.

Next, the controller 10 determines if the detection time has arrived (step S105), and waits until the detection time arrives. This embodiment is configured to periodically check if there was a touch operation. The time for checking for touch operations is referred to herein as the detection time. If the detection time has arrived in step S105, the controller 10, through the light-emitting element driver 52 and light detecting element driver 54, turns the light-emitting elements and light detecting elements in the detection areas on (step S110). Note that the light-emitting elements and light detecting elements outside the detection areas are always off.

Next, the controller 10 determines if there was a touch in the touch operation acceptance areas and detection areas (step S115), and if there was a touch, adds the current touch position to the touch position history in RAM (step S120). The touch position history stores in chronological order a specific number (at least two, the previous touch and the current touch, but possibly including all touches from the beginning to the end of the touch operation) of new touch positions from when the touch operation starts until the touch operation ends (the finger or stylus is lifted from the flat panel display 51).

Next, the controller 10 determines if a touch operation started (the touch position was not detected at the previous detection time) after the current detection time (step S125). If a touch operation was started after the current detection time, the controller 10 determines if the starting position of the touch operation was in a restricted area (step S130). In screen 510, list area 512 is an example of a restricted area. If step S130 determines the starting position of the touch operation is in a restricted area, the controller 10 sets a rectangle that includes the touch position and is long (the length of the restricted direction is longer than the length of the side perpendicular to the restricted direction) in the restricted direction (the direction corresponding to the effective detection component in the direction of touch position movement) as the next detection area (step S135), and turns the light-emitting elements and light detecting elements corresponding to the current detection area off (step S165). After step S165, the controller 10 returns to determining the detection time in step S105.

A specific example is described with reference to FIG. 5 and FIG. 6. In FIG. 5, T1 denotes the touch position. When the touch operations starts in the list area 512 as indicated by touch position T1 in this example, a rectangular area Z2 that includes the touch position T1 and is long on the vertical axis (the restricted direction of list area 512) is set as the next detection area as shown in FIG. 6.

When the touch operations starts, the direction of movement is unknown, but when a swipe is done in the list area 512, the likelihood is high that the direction of movement (direction of the swipe in this example) will be parallel to the vertical, and the likelihood is low that the touch destination will be outside the detection area and the final touch position will not be detected, even if the length on the horizontal axis of the next detection area is shorter than the length on the vertical axis.

If in step S130 the starting position of the touch operation is not determined to be in a restricted area, the controller 10 sets a rectangular area including the touch position as the next detection area (step S140), and goes to step S165.

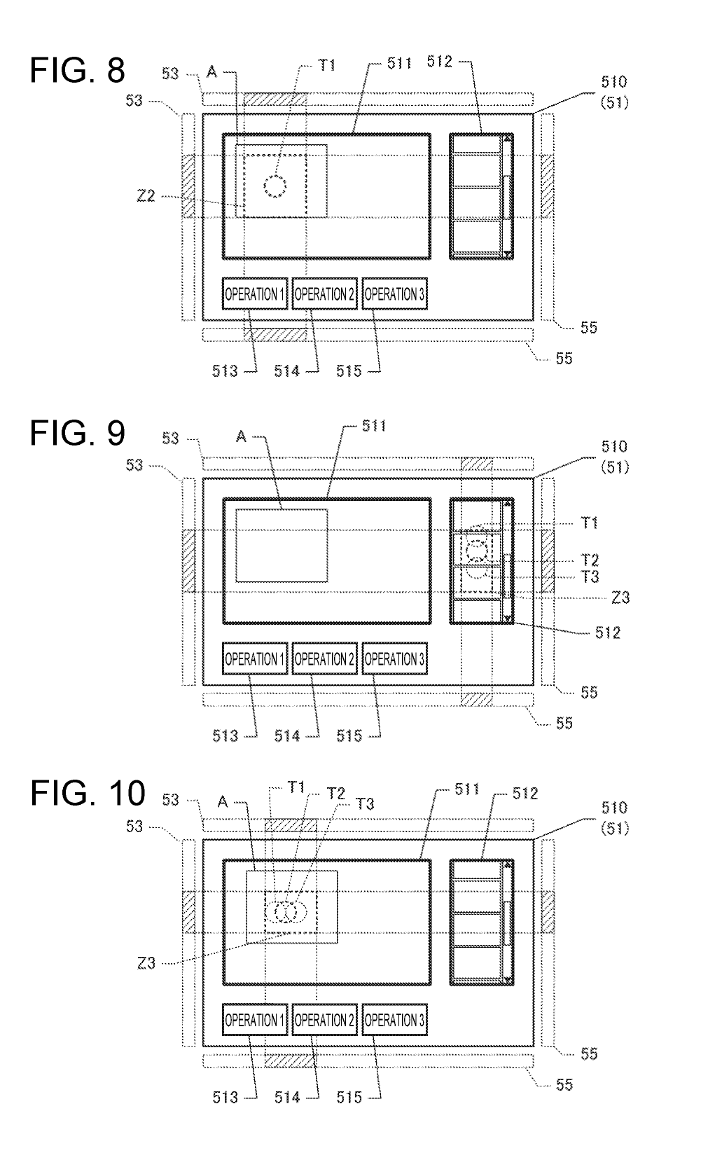

This operation is described more specifically with reference to FIG. 7 and FIG. 8. If, as shown in FIG. 7, the touch operation starts from touch position T1 in the free-design area 511, a rectangular area Z2 including the touch position T1 is set as the next detection area as shown in FIG. 8. Because the effective detection component of movement is not restricted in the free-design area 511, the rectangular area Z2 is not long in any specific direction, and instead is a square centered on the touch position T1. Note that when the touch position T1 is near an edge of the free-design area 511, the rectangular area Z2 is obviously not limited to being a square centered on the touch position T1.

Note that when the touch operation starts in any of button areas 513, 514, 515, the controller 10, for example, sets a rectangular area in the button area including the touch position as the next detection area.

Next, when the start of a touch operation is not detected in step S125, that is, when it is determined that the touch operation continues from the previous detection time, the controller 10 references the touch position history to determine if the current touch position moved from the last touch position (step S145). If movement is not detected in step S145, that is, if the touch remains at the previous position, control goes to step S130.

If movement is detected in step S145, the controller 10 determines if the present touch position (current touch position) is in a restricted area (step S150). If in step S150 the current touch position is determined to be in a restricted area, the controller 10 sets, as the next detection area, a rectangular area that includes the current touch position and is long in the restricted direction (the length in the restricted direction is longer than the length in the direction perpendicular to the restricted direction), and the length in the restricted direction is a length corresponding to the speed of the movement (step S155), and then goes to step S165.

This is described more specifically with reference to FIG. 9.

For example, the controller 10 calculates the speed of movement in the restricted direction (the vertical axis in this example) based on the previous touch position T1, the current touch position T2, and the detection period. Assuming movement in the same direction as the direction from the previous touch position T1 to the current touch position T2 and at the same speed as the calculated speed of movement, the controller 10 then predicts the next touch position T3 referenced to the current touch position T2.

The controller 10 then sets as the next detection area a rectangular area Z3 that includes the current touch position T2 and next touch position T3, and has a length on the vertical axis, which is the restricted direction, that is greater than the length on the horizontal axis. The length of the rectangular area Z3 on the vertical axis is set longer when the speed of movement is fast than when the speed of movement is slow. For example, multiple thresholds for comparison with the speed of movement may be set in steps, and when the speed of movement is greater than a particular threshold, the controller 10 sets the length of the rectangular area Z3 in the restricted direction longer than when the speed of movement is slower than the threshold. In another example, the controller 10 increases the length of the rectangular area Z3 in the restricted direction as the speed of movement increases. This reduces the chance that the actual destination of the swiping motion will go outside the detection area and the touch position will not be detected at the next detection time.

Note that when the rate of acceleration to the current touch position is greater than a predetermined standard, the length of the rectangular area Z3 in the restricted direction may be set longer than when the rate of acceleration is less than the standard. When the user has scrolled to the bottom of the list, the next detection area may be set on the assumption that the user will next swipe in the opposite direction. When the predicted touch position is outside the list area 512, the controller 10 sets the predicted touch position to the end of the list area 512 on the downstream side in the direction of movement.

When the current touch position is determined in step S150 to not be in a restricted area, the controller 10 sets as the next detection area a rectangular area including the touch position and having a length in the direction of movement greater than the length in the direction perpendicular to the direction of movement, the length in the direction of movement also corresponding to the speed of movement (step S160), and then goes to step S165.

This is described with reference to FIG. 10. In this example the controller 10 acquires the direction of movement to the current touch position T2 based on the previous touch position T1 and the current touch position T2. Based on the previous touch position T1, the current touch position T2, and the detection period, the controller 10 also calculates the speed of movement to the current touch position T2. The controller 10 then calculates the next touch position T3 assuming that the predicted direction of movement from the current touch position T2 is the same as the direction of movement to the current touch position T2, and the predicted speed of movement from the current touch position T2 is the same as the speed of movement to the current touch position T2. The controller 10 then sets as the next detection area a rectangular area Z3 including the current touch position T2 and next touch position T3. The length of the rectangular area Z3 in the direction of movement is set longer when the speed of movement is fast than when the speed of movement is slow.

In the example in FIG. 10, the direction of movement of the touch position is along the horizontal axis (an example of a first direction), and the rectangular area Z3 is longer on the horizontal axis than on the vertical axis.

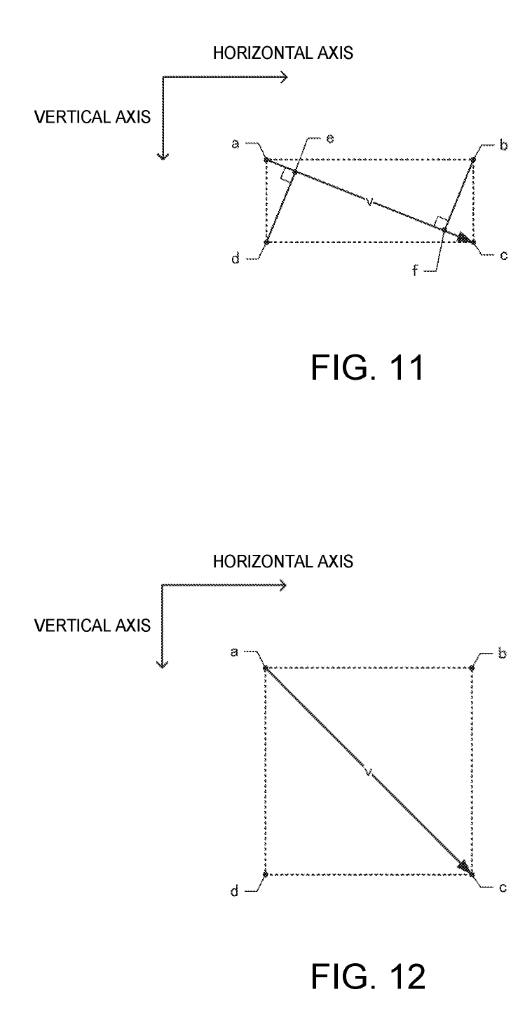

As shown in FIG. 11, when the direction of movement v (an example of a first direction) of the touch position is not parallel to the horizontal axis or the vertical axis, a rectangular area (abcd) that is longer in the direction of movement v (the length of line segment ac) than the length in the direction perpendicular to direction of movement v (the sum of the length of segment ed and the length of segment bf) may be set as the next detection area (where the current touch position is on line segment ac).

Note that as shown in FIG. 12, if the length of the horizontal component (the length between a and b) of the direction of movement v (an example of a first direction) and the length of the vertical component (the length between a and d) are equal, a rectangular area (abcd) with the same length in the direction of movement v (length of line segment ac) and the length in the direction perpendicular to the direction of movement v (length of line segment bd) may be set as the next detection area (where the current touch position is on line segment ac).

Note that if the touch position is moving in the first direction, and the distance moved in the first direction is longer than the distance moved in the direction perpendicular to the first direction, a rectangular area that includes the touch position and is longer in the first direction than in the direction perpendicular to the first direction may be set as the next detection area. More specifically, in the example in FIG. 11, the touch position is moving on both the horizontal axis and the vertical axis, and the distance moved (length ab) on the horizontal axis (corresponding to the first direction) is greater than the distance moved (length ad) on the vertical axis. A rectangular area that is longer on the horizontal axis (first direction) than the vertical axis can therefore be set as the next detection area.

If the current touch position is in any of button areas 513, 514, 515, the controller 10 sets, as the next detection area, a rectangular area that includes the current touch position and is inside the area of the button that was touched.

The light-emitting elements and light detecting elements corresponding to the next detection area set as described above are turned on in step S110 in the next detection cycle, and the touch position in that detection area is detected. Note that when a touch is not detected in step S115, the controller 10 clears the touch position history (step S170).

As described above, this embodiment of the invention dynamically sets, according to the movement of the touch position, detection areas for actually detecting touch operations in the touch operation acceptance areas. As a result, power consumption can be further reduced compared with a configuration in which the detection area always covers all of all touch operation acceptance areas. The cumulative emission time of the light-emitting elements can also be suppressed, helping to extend the service life of the light-emitting elements.

Note that because the light-emitting elements and light detecting elements corresponding to the areas outside the detection area are not turned on, the touch position detection precision in the detection area may be considered greater than the detection precision of touch positions in areas outside the detection area. This configuration also detects the touch position with greater precision in the detection area than outside the detection area.

The light-emitting elements and light detecting elements may also be turned on less frequently in areas outside the detection area than in the detection area to enable detecting the touch position. For example, the light-emitting elements and light detecting elements may be turned on to detect the touch position at every detection period within the detection area, and in areas outside the detection area, the light-emitting elements and light detecting elements may additionally be turned on once every certain number of detection periods to detect the touch position. By thus reducing the number of detection periods, the power consumption per unit area used for detection can be reduced and detection precision can be reduced.

In an electronic device achieving the foregoing objective, the destination to which a touch position moves is the point to which the user moves a tool, such as a finger or stylus, in contact with the touch panel in a moving operation (variously referred to as a swipe, slide, drag, flick, or move, for example), and is the position of the tool after a unit time has past, for example. The destination may be expressed by the coordinates of one point, or expressed as an area or range. Multiple destinations may also be predicted, or only one destination may be predicted.

The destination is predicted based on at least the current touch position. For example, the destination may be predicted using one or a combination factors including: the type of area associated with the current touch position; the relative position of the currently touched part to the area with which the current touch position is associated, and a previously acquired speed of movement in typical movement operations; a statistical value of the speed of movement in past moving operations by the user of the electronic device; the speed of movement to the current touch position; the rate of acceleration to the current touch position; and the direction of movement to the current touch position.

The first area in this example anticipates a single area including both the touch position and the destination. The first area may also include multiple separate areas respectively containing the touch position and the destination.

The second area is an area not overlapping the first area.

The controller controls the touch panel to detect the touch position with greater precision in the first area than a second area. More specifically, in the second area, the controller at least does not detect the touch position with greater precision than in the first area.

The first area and the second area also change dynamically in conjunction with movement of the touch position.

In an electronic device according to the invention, the controller may make the first area longer in the direction from the current touch position to the destination when the speed of movement to the current touch position is fast than when the speed of movement is slow. Assuming that the speed of movement from the current touch position increases as the speed of movement to the current touch position increases, the distance from the current touch position to the destination after the same amount of time increases. The length of the first area in the direction from the touch position to the destination is therefore also increased. By thus defining the first area, the chance of the actual destination being outside the first area and the touch position at the destination becoming difficult to detect can be reduced.

In an electronic device according to the invention, when the touch position is included in a restricted area that restricts the effective detection component of the direction of movement of the touch position to the restricted direction, the controller may define the first area to a shape in which the length in the restricted direction is longer than the length perpendicularly to the restricted direction. In a restricted area limiting the effective detection component of the direction of movement to the restricted direction, the likelihood of an operation moving the touch position perpendicularly to the restricted direction is low, and even if the touch position moves perpendicularly to the restricted direction, the likelihood is high that such perpendicular movement will not be greater than movement in the restricted direction. As a result, even if the length of the first area in the direction perpendicular to the restricted direction is shorter than the length in the restricted direction, the likelihood that the destination will be outside the first area is low. If the length of the first area in the restricted direction is the same, and the length in the direction perpendicular to the restricted direction is shorter than the length in the restricted direction, the first area will be narrower than if the length in the direction perpendicular to the restricted direction is not shorter than the length in the restricted direction. By narrowing the first area, power consumption by the touch panel can be reduced.

The touch panel of an electronic device according to the invention may be an optical touch panel. In this configuration, the controller may cause the light source corresponding to the first area to emit more frequently than the light source of the second area.

If the touch panel is an optical device, the controller may increase the number of light sources that emit in the same unit area of the first area as in the second area. By thus emitting more frequently, or increasing the number of emitting light sources per unit area, the detection precision increases and power consumption per unit area increases. By dynamically setting the first area and second area according to movement of the touch position in the screen area of the touch panel, and defining the area for detecting the touch position by increasing the detection precision or the power consumption per unit area of the first area over the second area, the touch panel is not limited to optical devices and may be any type of touch panel.

For example, when a resistive touch panel is used, voltage may be applied to all transparent electrodes in the first area, while applying voltage to only every other transparent electrode in the second area. In this way, that detection precision is greater in the first area than the second area, and power consumption per unit area is greater, means that total power consumption can be reduced compared with a configuration driving the entire screen in the same way as the first area, and detection precision can be increased compared with a configuration driving the entire screen in the same way as the second area.

The foregoing embodiment is described using the example of a single touch operation, but the invention can obviously also be applied to multi-touch panels. In the case of a touch panel enabling multi-touch operations, a first area may be defined for each touch position, or a single first area may be defined to include multiple touch positions. The first area may also be defined after a maximum multi-touch limit is reached, or as the number of simultaneous touches increases.

In the first embodiment described above, moving an image in the edit area of the communication area of a postcard is used to describe moving the touch position freely, but the invention can also be applied to moving the trimming boundaries in a photograph editor, or move buttons when customizing a menu window, for example.

The functions of parts described in the following claims may be embodied by hardware resources whereby the configuration itself determines the function, by hardware resources of which the function is determined by a program, or by combinations of these. The functions of specific parts are also not limited to embodiments of physically discrete, independent hardware resources. At least some functions may be embodied by a combination of multiple, physically discrete hardware resources.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

What is claimed is:

1. An electronic device comprising:
a touch panel configured to detect a touch position; and
a controller configured to execute a detection operation with greater power consumption per unit area in a first area including the touch position than in a second area different from the first area.

2. An electronic device comprising:
a touch panel configured to detect a touch position; and
a controller configured to detect the touch position with greater precision in a first area including the touch position than in a second area different from the first area.

3. The electronic device described in claim 1, wherein:
the controller predicts the destination to which the touch position moves; and
the first area is an area including the touch position and the destination.

4. The electronic device described in claim 1, wherein:
when the touch position is moving in a first direction, the first area is an area that includes the touch position, and has a length in the first direction that is longer than in the direction perpendicular to the first direction.

5. The electronic device described in claim 1, wherein:
the controller sets the first area to a shape that is longer in the direction from the current touch position to the destination when the speed of movement to the current touch position is fast than when the speed of movement is slow.

6. The electronic device described in claim 1, wherein:
the controller, when the touch position is contained in a restricted area that restricts to a restricted direction the effective detection component of the direction of movement of the touch position, sets the first area to a shape that is longer in the restricted direction than in the direction perpendicular to the restricted direction.

7. The electronic device described in claim 1, wherein:
the touch panel is an optical device; and
the controller causes the light source of the first area to emit more frequently than the light source of the second area.

8. A nonvolatile storage medium of a control program that is read by an electronic device having a touch panel configured to detect a touch position,
the control program causing the electronic device to execute a detection operation that consumes more power per unit area in a first area including the touch position than in a second area different from the first area.
